(19) United States
(12) Patent Application Publication
(10) Pub. No.: US 2013/0056397 A1
(43) Pub. Date: Mar. 7, 2013

(54) Wheelbarrow and Sieve

(71) Applicant: George GELLER, Scoth Plains, NJ (US)

(72) Inventor: George GELLER, Scoth Plains, NJ (US)

(21) Appl. No.: 13/226,077

(22) Filed: Sep. 6, 2011

(51) Int. Cl. B07B 1/04

(52) U.S. Cl. 209/352

(57) ABSTRACT

In combination, a wheelbarrow and a cooperating sieve. The sieve has an outer frame and a central screen. One end of the frame is mountable on a lip of one side wall of the wheelbarrow as the remainder of the sieve is held in position by engagement of the end of the sieve opposite from the channel with the opposite side wall of the wheelbarrow.

### FIELD OF THE INVENTION

This invention relates to a wheelbarrow and sieve combination.

### BACKGROUND OF THE INVENTION

A combination of a wheelbarrow and a sieve is of course well-known and advantageous for many uses, primarily for separating soil or the like from other materials such as weeds or the like. However, sieves known heretofore for use with wheelbarrows have been either totally inflexible, i.e., intended for use with only a wheelbarrow of a given size and shape and/or inconvenient to mount on the wheelbarrow.

For example, the sieve shown in the Curtis, U.S. Pat. No. 5,622,266 is usable only with a wheelbarrow having an upper, outer periphery of a specific shape. It is noted that a matching sieve must be manufactured for any given wheelbarrow and in its simplest version, the sieve comprises many elements which are suitably fastened together by screws, bolts, rivets or the like.

The Jenkins, U.S. Pat. No. 2,767,886 shows a sieve on the bottom of the wheelbarrow which is entirely different from the arrangement with a sieve serving as a separator on the top of the wheelbarrow.

Donnington, U.S. Pat. No. 4,350,584 shows a sieve connectable with a wheelbarrow, but this patent shows a complicated arrangement of projections and recesses as a way to adapt the sieve shown therein for different sizes and shapes of wheelbarrows.

Thus, there exists a need for a new and improved sieve, combinable with a wheelbarrow, which has advantages of simplicity and flexibility.

### SUMMARY OF THE INVENTION

The present invention provides a new combination of a sieve and a wheelbarrow wherein the sieve is very easily mounted onto a wheelbarrow and in fact is easily mounted onto a large number of different sizes and shapes of wheelbarrows.

These advantages of the present invention are achieved by providing a sieve which mounts onto the wheelbarrow in a very simple way and has dimensions such that it can fit essentially any conventional wheelbarrow. To achieve this result, the present invention recognizes and takes advantage of certain aspects of all conventional wheelbarrows. A first aspect is that all wheelbarrows, even if curved in the front and the back, have essentially straight, parallel side walls and those side walls are tapered downwardly and inwardly. Recognizing these wheelbarrow characteristics, the present invention provides a sieve with a channel which engages on one of the parallel side walls and wherein the cross dimension of the sieve extending across the wheelbarrow is such that the opposite end of the sieve securely engages the opposite side wall.

The term “conventional wheelbarrow” refers to non-commercial wheelbarrows sold in home and garden outlets, as contrasted with larger and specialized commercial wheelbarrows. Applicant has observed that while these conventional wheelbarrows may come in different shapes and sizes, which sizes are usually four cubic feet and six cubic feet, they all have an essentially uniform width of approximately 26.5 inches, plus or minus an inch or so.

As a result thereof, the cross dimension of the sieve, if selected properly, will securely engage the opposite side wall of any conventional wheelbarrow. Conventional wheelbarrows have inwardly downwardly tapering side walls. For a wheelbarrow with a width on the larger side of the narrow range of widths, the outer end of the sieve will fall short of the lip on the opposite side wall and rest against the upper part of the tapered part thereof. For wheelbarrow widths on the smaller side of the range, the opposite end will rest on top of the lip of the opposite side wall.

The present invention also takes advantage of the fact that the straight side walls of conventional wheelbarrows are all generally of the same length as each other. Using this observation, Applicant has designed the longitudinal dimension of the sieve, i.e., the dimensions in the front to back direction of the wheelbarrow, as large as permitted by the length of the straight sides, stopping short of the curvatures of the wheelbarrow which transition into the front and rear thereof.

It is an object of the present invention to provide a new combination of sieve and wheelbarrow, wherein the sieve is easy to mount onto the wheelbarrow.

It is another object of the present invention to provide a new sieve and wheelbarrow combination wherein the sieve is universally mountable onto all conventional wheelbarrows.

These and other objects of the present invention will become apparent from the detailed description which follows.

### BRIEF DESCRIPTION OF THE FIGURES

Preferred embodiments of the present invention will now be described by way of example with respect to the accompanying drawings of which:

FIG. 1 is a top plan view of a sieve and wheelbarrow combination, in accordance with the present invention.

FIG. 2 is a cross sectional view, taken along line 2-2 of FIG. 1.

FIG. 3 is an enlarged perspective view of the sieve, viewed from below.

### DETAILED DESCRIPTION OF THE PREFERRED EMBODIMENTS

There follows a detailed description of preferred embodiments, wherein like elements are represented by like numerals throughout the several views.

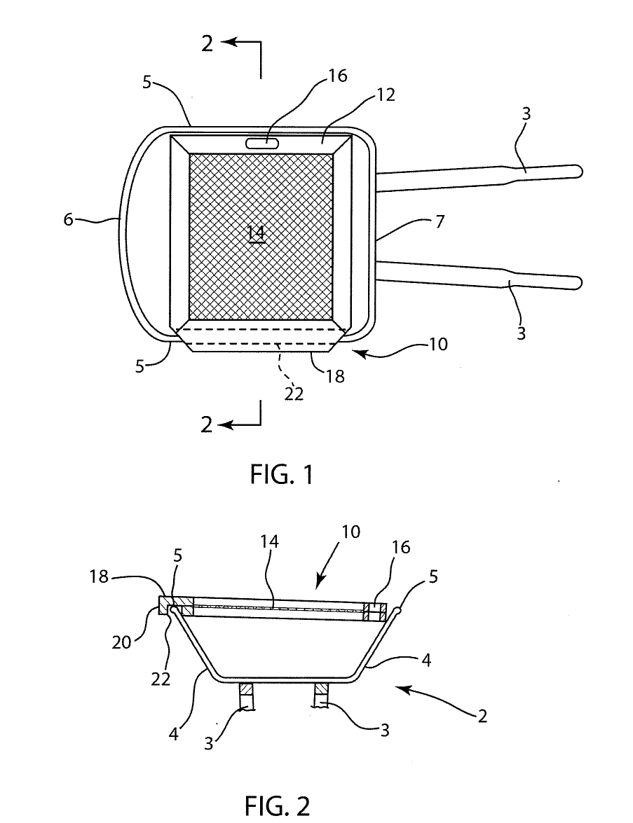

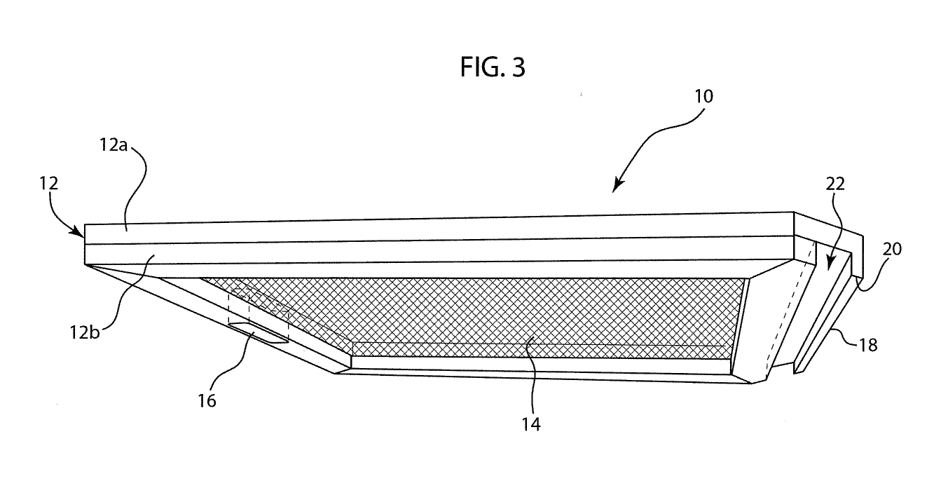

Referring to FIGS. 1-3, a sieve 10 comprises an outer frame 12 which includes an upper frame part 12a and a lower frame part 12b. A sifting screen 14 is mounted to the frame, and specifically, its outer periphery is engaged and held between the upper and lower frame parts 12a and 12b. The openings of the sieve may be of any suitable size as desired for a given application. Depending on the intended use, common opening sizes for such a screen may be ¼ inch or ½ inch, depending on the size and characteristics of the materials which are intended to remain on top of the screen while the soil falls therethrough. The sieve may be made out of any suitable material such as wood or plastic molding. A typical thickness of the sieve might be approximately 1.5 inches which gives it stability. However, it is contemplated that the sieve can be of any thickness, provided that it has sufficient stability to remain firmly in place when mounted on the wheelbarrow.

The sieve 10 is specifically constructed and adapted for use with a conventional wheelbarrow as shown at 2 which comprises a pair of generally straight side walls 4 with upper lips 5, a front wall 6 and a rear wall 7. Numeral 3 shows schematically a conventional wheelbarrow understructure which is known, per se, and therefore not shown in detail.

In order to simplify the task of mounting the sieve onto the wheelbarrow for use on different sizes and shapes of conventional wheelbarrows, the sieve includes an end frame portion 18 with a downwardly turned flange 20 which forms with an end of the lower frame part 12a, a generally straight channel 22. At the end of the sieve opposite from the channel 22 is a through-opening 16 to be grasped by a user's hand to lift that part of the sieve.

Engagement of the sieve with the wheelbarrow is made convenient, flexible and secure by the fact that the channel 22 fits neatly and securely onto a side wall lip 5 of a wheelbarrow while the opposite end thereof tilts down to engage the opposite sidewall 4. The handle opening 16 is positioned to conveniently allow the user to grasp that end of the sieve and lift that end upwardly while the user grasps the end with channel 22 with the other hand, thereby removing the sieve from the wheelbarrow with the same convenient easy movement as that followed for mounting the sieve onto the wheelbarrow.

The above-described construction of the sieve is such that it is universally applicable to virtually all conventional wheelbarrows. A preferred cross dimension of the sieve, i.e., the direction across the wheelbarrow as shown in FIG. 2, is approximately 25.75 inches. The distance across the top of a conventional wheelbarrow, as shown in FIGS. 1 and 2, is approximately 26.50 inches. The result is that, for this wheelbarrow, the end of the sieve opposite from the channel will move down below the lip 5 of the opposite side wall and rest securely against the tapered wall 4 located therebeneath.

The width of conventional wheelbarrows will vary over only a small range. For a wheelbarrow of a greater width than as shown in FIGS. 1 and 2, the opposite end of the sieve will be securely engaged with a lower part of the tapered side wall, and for a narrower wheelbarrow, the opposite end of the sieve will sit on top of lip 5 of the opposite side wall 4.

To allow the sieve to be as long as possible in the longitudinal, i.e., the front to back direction of the wheelbarrow, the sieve may extend as far as the straight sides of the wheelbarrow, terminating where those sides curve to transition into the front and back walls of the wheelbarrow.

The sieve has chamfered edges adjacent the ends of the channel 22 to adapt to the curvatures of the wheelbarrow transitioning from the sides into the front wall and back wall thereof.

In operation, the user would place the channel 22 on a lip 5 of a straight side wall 4. After placing the channel onto a lip 5 of the wheelbarrow, the user simply allows the sieve to pivot downwardly about its engagement of the channel with its lip 5 until the sieve engages the opposite wall of the wheelbarrow, whether that engagement is onto the lip 5 or onto the tapered wall of the opposite side wall. The user would select a sieve having openings of a size appropriate for the nature of the materials to be retained by the sieve.

Although the invention has been described above with respect to preferred embodiments, it will be understood by those skilled in the art that modifications and variations are contemplated within the spirit and scope of the invention.

1. In combination:
a wheelbarrow and a sieve adapted to cooperate with the wheelbarrow,
the wheelbarrow having a pair of generally straight inwardly downwardly tapering side walls, each having an upper lip,
the sieve including an outer frame and a central screen secured to the frame,
the frame having a channel along the bottom of one end thereof, which channel fits onto one of said side wall lips,
and the remainder of the sieve shaped to fit onto the wheelbarrow with the end opposite from said one end securely engaging the side wall opposite from said one side wall.

2. The invention of claim 1, wherein the sieve is generally rectangular and the channel is located along a short side of the rectangle.

3. The invention of claim 2, wherein the outer frame has a handle opening at an end thereof opposite from said one end.

4. The invention of claim 1, wherein the sieve comprises a frame having an upper frame part and a lower frame part, and the screen is secured between the upper and lower frame parts.

5. The invention of claim 4, wherein the upper part and the lower frame part are made of wood.

6. The invention of claim 1, wherein the frame is made of molded plastic.

7. The invention of claim 1, wherein the opposite end of the sieve engages a tapering portion of the opposite side wall.

8. The invention of claim 1, wherein the opposite end of the sieve engages an upper lip of the opposite side wall.
